(19) United States
(12) Patent Application Publication
(10) Pub. No.: US 2009/0150532 A1
(43) Pub. Date: Jun. 11, 2009

(54) METHODS AND SYSTEMS FOR CLIENT COMPUTER MANAGING MULTIPLE SERVERS

(75) Inventors: Sheng-Lung Chan, Sijhih City (TW); Kwo-Chi Chang, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/951,487

(22) Filed: Dec. 6, 2007

(51) Int. Cl. G06F 15/173

(52) U.S. Cl. 709/223

(57) ABSTRACT

A method for a client computer managing a plurality of servers via a network is provided. The method comprises the following steps. A selection list of the servers supporting a keyboard-video-mouse (KVM) over IP (iKVM) function is displayed in the client computer in which the selection list provides information corresponding to each server. At least one server is selected from the selection list in the client computer. Then, the client computer is connected to the selected server by logging into the selected server automatically such that the client computer is capable of controlling the selected server.

### BACKGROUND OF THE INVENTION

1. Field of the Invention

The invention relates to remote control, and more particularly, to systems and methods for a client computer managing a plurality of servers by using a KVM (keyboard-video-mouse) module.

2. Description of the Related Art

Remote control systems commonly use tools to remotely access and control network nodes such as computer servers from a local computer such as a client computer. These typical remote access tools permit users on the client computer to manage and restore the operations of the servers remotely. Recently, a Keyboard-Video-Mouse (KVM) module is very popular for such remote control systems. The KVM module is a hardware device that allows a user to control multiple computers from a single keyboard, video monitor and mouse. An advanced technique called KVM over IP (iKVM) allows multiple computers to be controlled remotely across a wide area network, local area network or telephone-line using the TCP/IP protocols by the KVM module of the local computer. In other words, a server can be remotely controlled from a client computer if it has an iKVM module supported iKVM function.

In a network having multiple servers, however, it is hard to recognize supported services and related authentication type of each server and member login information for each server.

FIG. 1A shows a conventional remote control system 100.

If a user in the client computer attempts to connect to the Server1, the user has to memorize the IP address of the Server1 (192.168.86.101) to request to connect to the Server1. After connected to the Server1, the user may need to manually input login information (such as username and password as shown in FIG.1B) to log into the Server1 so as to connect to and control the Server1. Similarly, if the user attempts to connect to the Server2, the user has to memorize the IP address of the Server2 (192.168.86.102) to request to connect to the Server2 and may need to input login information to log into the Server2. If many servers are presented and to be controlled or switched, many IP addresses and authentication information corresponding thereto must be memorized and inputted, making remote controlling difficult and complicated.

Further, when a new server is added into the network, due to the IP address and authentication information of the new server being unknown and can not be found from the historical data, the user is unable to add the new server into the remote control list.

### BRIEF SUMMARY OF THE INVENTION

Methods and systems for a client computer managing a plurality of servers are provided. An embodiment of a method comprises the following steps. A selection list of the servers supporting a keyboard-video-mouse (KVM) over IP (iKVM) function is displayed in the client computer. The selection list provides information corresponding to each server. At least one server is then selected from the selection list in the client computer. Next, the selected server is logged into to connect the client computer to the selected server such that the client computer is capable of controlling the selected server.

Remote control systems are further provided. An exemplary embodiment of a remote control system comprises at least one server and a client computer coupled to the server via a network. The server has an iKVM module for supporting KVM over IP function. The client computer selects the at least one server from a selection list, such that the client computer logs into the selected server, connects to the selected server and controls the selected server.

Another embodiment of a method for a client computer managing a plurality of servers comprises the following steps. A viewer application is provided in the client computer. Servers supporting a KVM over IP (iKVM) function from the plurality of servers are searched by the viewer application. The supported servers and information corresponding thereto are listed, wherein the listed information of each supported server provides information indicating whether each support server comprises an IPMI module. At least one server are selected from the listed servers by the client computer. Authentication information corresponding to the selected server is loaded by the viewer application to connect the client computer to the selected server such that the client computer is capable of controlling the selected server.

### BRIEF DESCRIPTION OF THE DRAWINGS

The invention can be more fully understood by reading the subsequent detailed description and examples with reference to the accompanying drawings, wherein:

FIG. 1A shows a conventional remote control system;

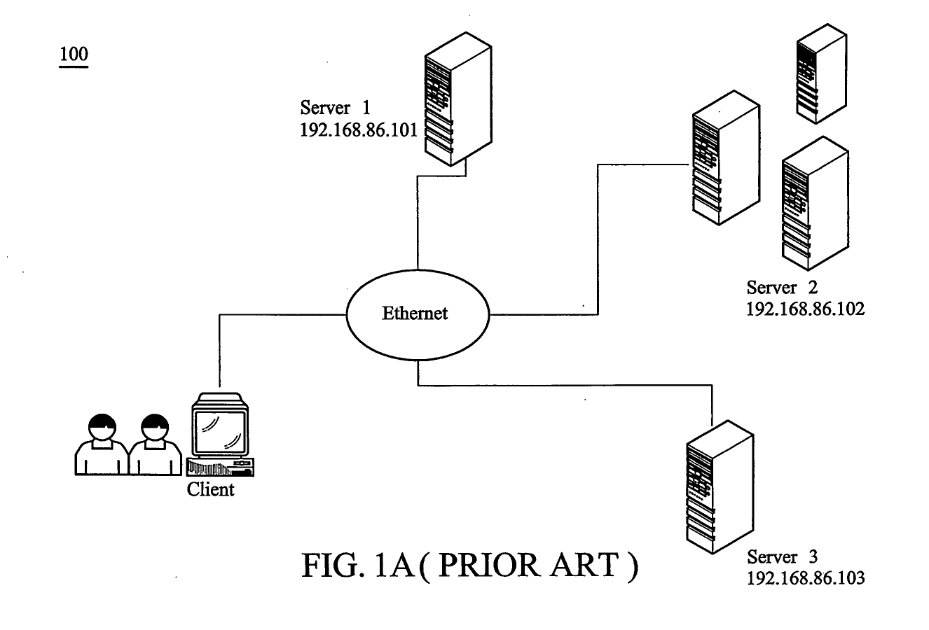

FIG. 1B shows a conventional authentication information;

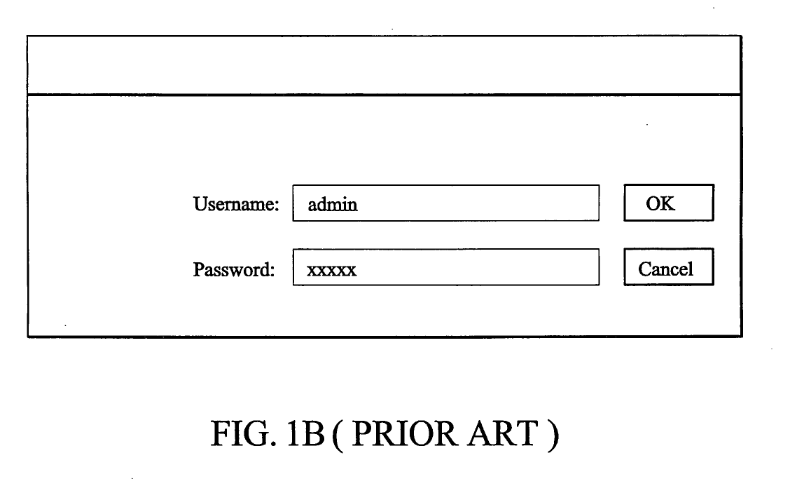

FIG. 2 shows an embodiment of a remote control system according to the invention;

FIG. 3 is a flowchart illustrating a management method for an embodiment of the remote control system for managing the servers according to the invention;

FIG. 4 is a diagram illustrating an exemplary selection list according to the invention;

FIG. 5 is a flowchart illustrating another management method for an embodiment of the remote control system for managing the servers according to the invention;

FIG. 6 is a flowchart illustrating an embodiment of a method for generating the selection list according to the invention;

FIG. 7 is a flowchart illustrating an embodiment of a method for adding a new server when the new server is presented according to the invention;

FIG. 8A is a diagram illustrating an exemplary switch menu according to the invention;

FIG. 8B is a diagram illustrating an exemplary display for switching servers by the hotkey according to the invention;

FIG. 8C is a diagram illustrating an exemplary display for switching servers by the split window according to the invention; and

FIG. 9 is a diagram illustrating an exemplary display for generating authentication information of a new server according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

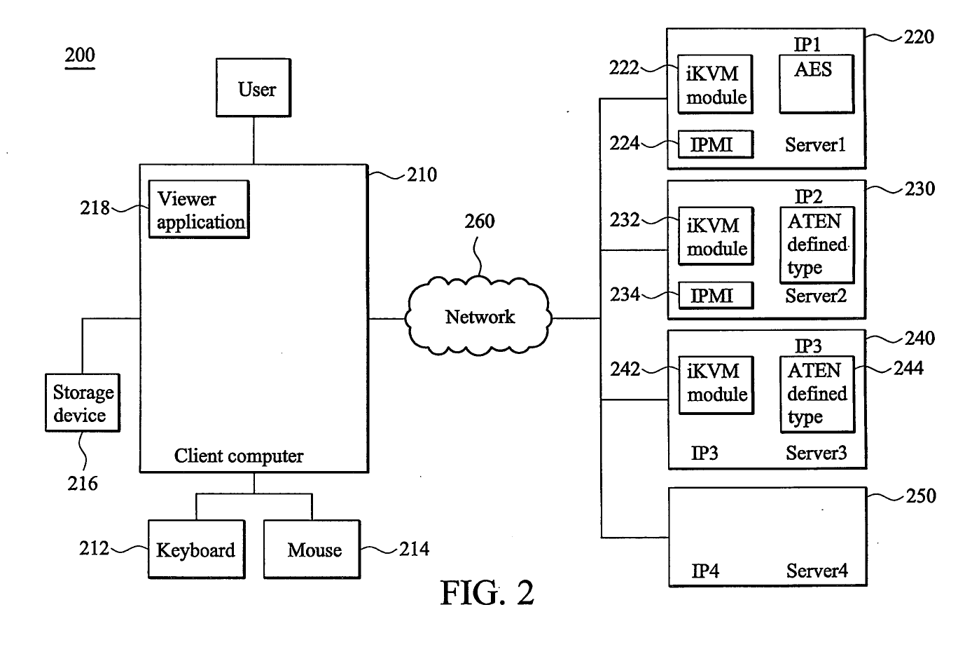

The invention is now described with reference to FIGS. 2 through 9, which generally relate to method for a client computer managing a plurality of servers via a network. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

Embodiments of the invention provide methods and systems for a client computer to manage a plurality of serves via a network. In one embodiment, a method for a client computer managing a plurality of servers via a network is provided. A viewer application is provided in the client computer and a user in the client computer is capable of remotely controlling the servers by the viewer application. When the viewer application is activated, the viewer application automatically searches all of the servers within a predetermined network area to find servers supporting an iKVM function and generates a selection list listed servers supporting the iKVM function and information corresponding thereto (e.g. IP address, authentication type and supporting services such as whether an IPMI module is supported). The user then selects one or more server to be managed or switched from the selection list and the client computer is automatically logged into the selected server using pre-saved authentication information corresponding to the selected server such that the selected server is connected to the client computer and can be controlled by the input device (e.g. mouse or keyboard) in the client computer without inputting or memorizing any IP address or authentication information.

According to the invention, if a new server is added into the network, the client computer is notified such that the client computer is capable of determining whether to allow the new server join to the network and displaying it in the selection list for user selection. Moreover, when more than one server is to be managed, users in the client computer may connect to those servers using the selection list and switch control between the servers by a hotkey or a split window.

FIG. 2 shows an embodiment of a remote control system 200 according to the invention. The remote control system 200 comprises client computer 210 and four servers 220, 230, 240 and 250 in which the client computer 210 and the servers 220-250 are connected to each other through a network 260. The network 260 may be wired or wireless network such as an Internet, an Ethernet, an Intranet, a local area network (LAN), a wide area network (WAN) or an IEEE 802.11 wireless network. Although the remote control system as shown depicts four servers connected to a client computer via a network, alternate embodiment of the remote control system may have connections between fewer or more servers and a client computer. For example, the remote control system allows at least one server or larger than four servers to connect to a client computer.

The client computer 210 further comprises a storage device 216. The storage device 216 may be a hard drive, magnetic drive, optical drive, thumb drive, portable drive, or nonvolatile memory drive. The client computer 210 also comprises an input device having a keyboard 212, a mouse 214 or similar to receive input signals therefrom and a display device (not shown), such as a liquid crystal display (LCD) monitor, for displaying. In one embodiment, the client computer 210 may be personal computer, notebook computer, desktop computer, laptop computer, personal digital assistant (PDA), cellular phone or any portable electronic device.

Each of the servers 220, 230 and 240 has at least one iKVM module supporting at least one KVM over IP (iKVM) function, making each server controllable by the client computer 210 through the network 260. When the iKVM function is supported by a specific server, the client computer 210 is capable of monitoring and controlling the specific server using the KVM (i.e. keyboard 212, video display and mouse 214) therein remotely via the connected network 260. The server may further comprise an Intelligent Platform Management Interface (IPMI) module for supporting an IPMI standard. The IPMI standard defines a set of common interfaces to computer hardware and firmware which system administrators can use to monitor system health and manage the system. The IPMI operates independently of the operating system (OS) and allows administrators to manage a system remotely even in the absence of the OS or the system management software, or even if the monitored system is not powered on. The IPMI module may provide information regarding to the server, such as CPU speed, temperature and so on. With the IPMI module, the client computer 210 is capable of remotely monitoring hardware information of the managed server, and can configure and control the managed server according to the monitored hardware information such as powering on, powering off or restarting the managed server when an error has been monitored. The authentication type for the server may be, for example, an advanced encryption standard (AES) type which is a 128-bit data encryption or a user-defined standard type.

For example, in the embodiment, servers 220 and 230 comprise IPMI modules 224 and 234, respectively. The server 220 has a first IP address IP1 with an AES authentication type. The server 230 has a second IP address IP2 with a user defined (e.g. ATEN defined) authentication type. The server 240 has a third IP address IP3 with a user-defined authentication type without supporting an IPMI function. The server 250 has a fourth IP address IP4 without supporting either an iKVM or an IPMI function.

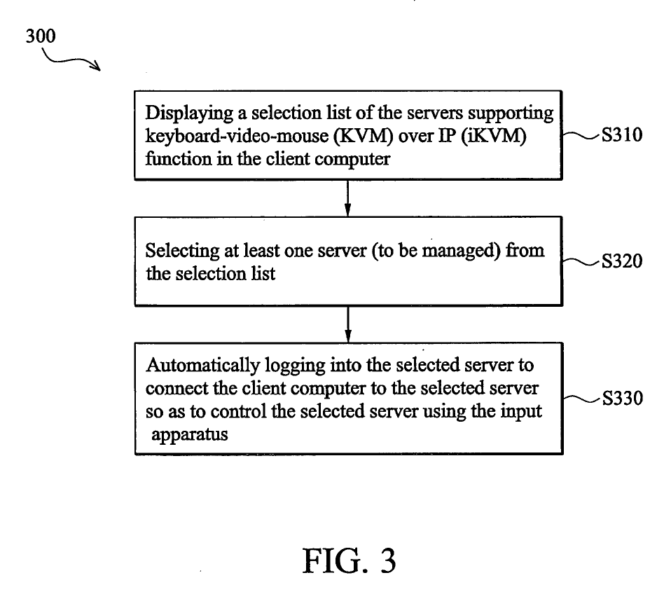

FIG. 3 is a flowchart illustrating a management method for the remote control system 200 for managing the servers according to the invention. In step S310, a selection list of the servers supporting an iKVM function is displayed in the client computer 210. The selection list provides information corresponding to each server and allows a user to select at least one of the servers within the displayed list.

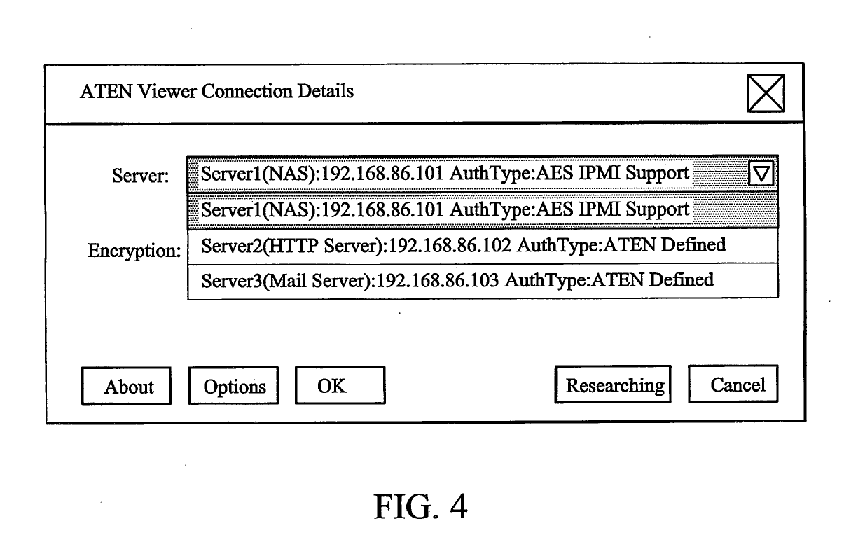

FIG. 4 is a diagram illustrating an exemplary selection list 400 according to the invention. As shown in FIG. 4, the selection list 400 at least comprises a server field and an encryption field wherein the server field represents each server that supports the iKVM function and information corresponding thereto while the encryption field represents encryption types used by each server. The corresponding information may comprise at least one of an IP address, a MAC address, an authentication type and a supported service of each server such as whether an IPMI function is supported by the server. All of the servers supporting the iKVM function within the predetermined network area will be found and listed in the selection list so the client computer 210 is capable of connecting to any of the listed server through the connected network 260. In one embodiment, the selected list is shown as a frame window or a GUI in the client computer 210.

Then, in step S320, at least one server (to be managed) is selected from the selection list in the client computer 210. Referring to FIG. 4, for example, three servers Server1-Server3 are listed and it is assumed that Server1 is to be managed. Therefore, Server1 220 has been selected. Note that the Server4 250 is also searched but not listed in the selection list 400 since it does not support the iKVM function. In one embodiment, the Server4 250 is also searched and listed in the selection list 400 even if it does not support the iKVM function or IPMI function.

It is observed that the IP address, the authentication type and the supported service type of the Server1 are “192.168.86.101”, “AES type” and “IPMI support”, respectively. After the Server1 has been selected, login information or the authentication information corresponding to the Server1 (e.g user ID and its password) will also be obtained. The login information or the authentication information of each server may be predefined and stored in advance and are accessible by the client computer 210 such that the client computer 210 may obtain that information corresponding to the selected server automatically without user interaction. The login information or the authentication information of each server may be retrieved from a predefined database or from a file in the client computer 210, or from a predetermined server connected to the network.

Accordingly, in step S330, the selected server (i.e. Server1) is automatically logged into using the retrieved authentication information such that the client computer 210 can be connected to the selected server. After the client computer 210 is successfully connected to the selected server (i.e. Server1), the user of the client computer 210 is capable of managing and controlling the selected server using the input device (keyboard or mouse). In this embodiment, due to the Server1 further comprises an IPMI module providing IPMI supported, the client computer 210 may also control the Server1 through the IPMI module within the Server1.

The client computer 210 further provides a viewer application that provides a user interface for displaying the selection list and for the user to select a server to be managed and to remotely monitor and control the server through the input device.

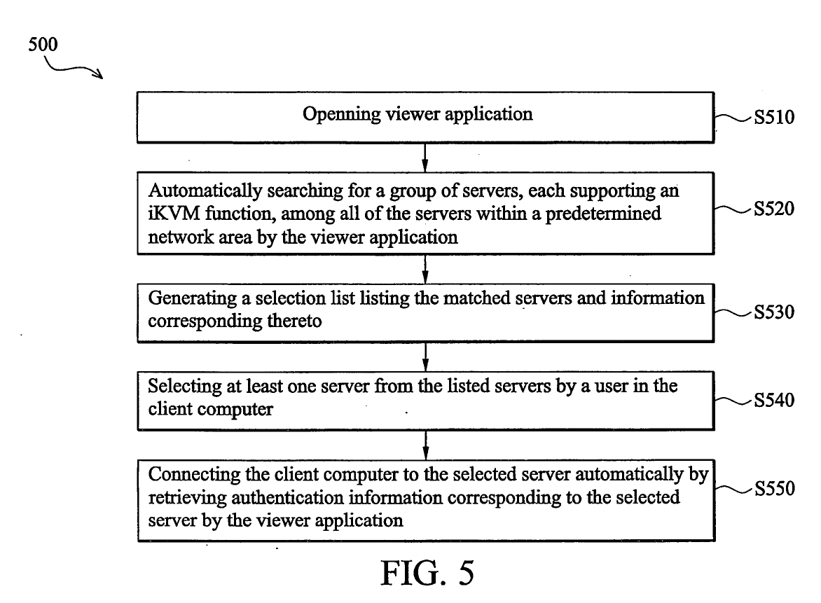

FIG. 5 is a flowchart illustrating another management method for the embodiment of the remote control system 200 for managing the servers according to the invention. When a user is going to perform a remote control operation in the client computer 210, the viewer application is provided and opened (step S510). Once it is opened, the viewer application automatically searches for a group of servers, each supporting an iKVM function, among all of the servers within a predetermined network area (step S520). It is to be understood that although only the iKVM function supported is as a query condition, the invention is not limited thereto. The viewer application may broadcast a message for finding a server that supports an iKVM function to the connected network and receive a reply message from each server supporting the iKVM function. Assume that 10 servers are within the predetermined network area, 10 servers will be searched. If 4 of 10 servers support iKVM function, those 4 servers will reply a message to the viewer application. Detailed description of the search flow to generate a selection list is provided later, and only briefly described herein.

After all servers within the predetermined network area has been searched, a selection list listing the matched servers and information corresponding thereto is generated (step S530). The listed information of each matched server may provide information indicating whether each searched server comprises an IPMI module.

Then, a user in the client computer 210 selects at least one server from the listed servers (step S540). Authentication information corresponding to the selected server are automatically retrieved and loaded by the viewer application to connect the client computer 210 to the selected server (step S550). Again, the user in the client computer 210 is capable of managing and controlling the selected server using the input device (keyboard or mouse) after the client computer 210 is successfully connected to the selected server.

To generate the selection list, a broadcast message and a specific protocol may be utilized between the viewer application of the client computer 210 and the servers.

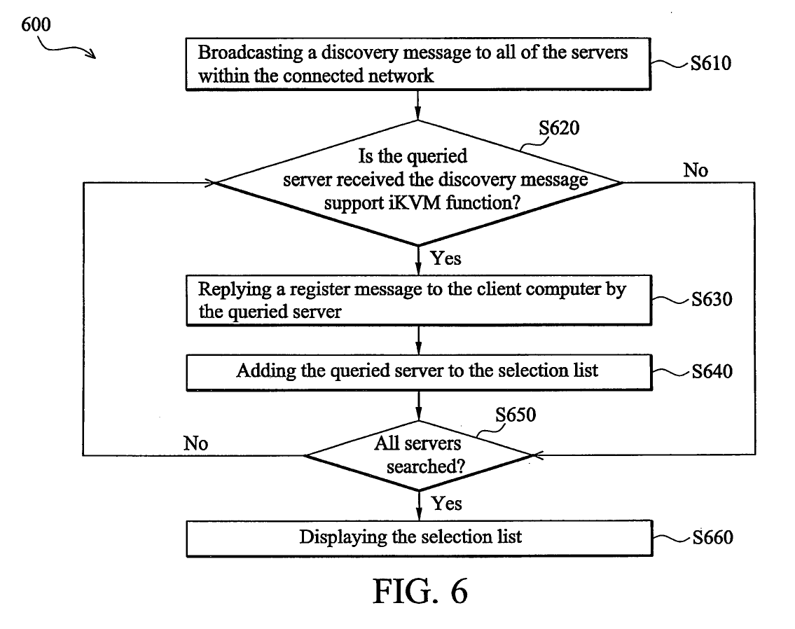

FIG. 6 is a flowchart illustrating an embodiment of a method for generating the selection list according to the invention. First, in step S610, the viewer application of the client computer 210 broadcasts a discovery message to all of the servers within a predetermined network area upon opening by the user from the client computer 210. It is to be understood that the predetermined network area may be defined and adjusted by the user using the viewer application such as pressing an “option” button of the viewer application to define the search area. The discovery message represents a request for finding a group of servers supporting the iKVM function. In step S620, it is determined whether a queried server received the discovery message supporting the iKVM function. If so (Yes in step S620), the server will reply a register message to the client computer 210 (step S630). The replied message may comprise at least one of an IP address, a MAC address, an authentication type and a supported service of each server such as whether an IPMI function is supported by that server. Once the client computer 210 received the replied register message from a queried server, the queried server message and its associated information, such as IP address, MAC address, authentication type and supported service, will be stored and listed in the selection list (step S640). Then, in step S650, it is determined whether all of the servers are searched. If not (No in step S640), steps S620-S640 are repeated to query each of other un-searched servers until all of them are searched. If all of the servers have been searched, the selection list is generated and displayed and thus the process is ended. If, in step S620, a queried server receiving the discovery message does not support the iKVM function, the queried server may ignore the discovery message or may reply another message for indicating that the requested service is not supported.

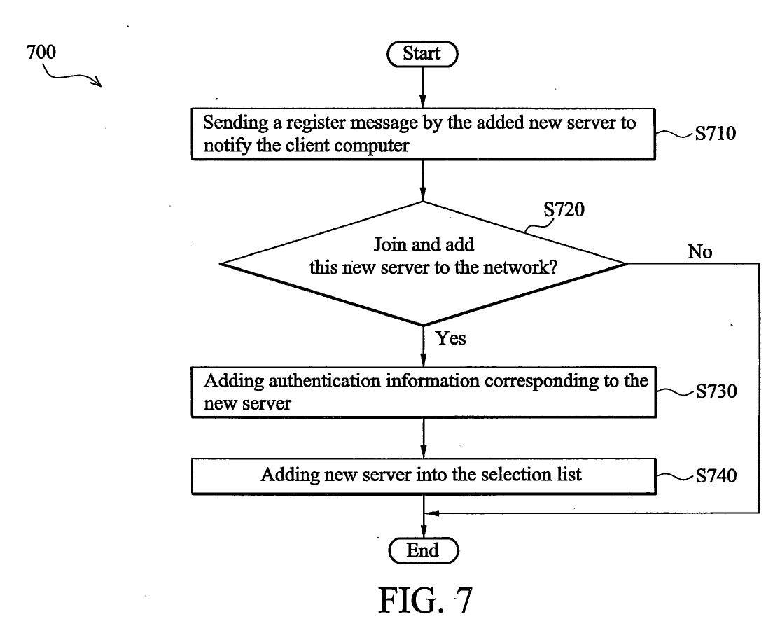

With the aforementioned broadcast message, all of the servers supporting iKVM function may be found by the client computer 210 and displayed in the selection list. The selection list, however, does not include any new server added into the connected network after client computer performs the search operation. In one embodiment, a new server may also be added into the selection list as shown in FIG. 7.

FIG. 7 is a flowchart illustrating an embodiment of a method for adding a new server when the new server is presented according to the invention.

In step S710, a register message is sent by the new added server to notify the client computer 210 that a new server is presented. For example, when receiving the register message, the viewer application may popup a dialog box indicating that a new server supporting an iKVM function is requesting to join the network. Similarly, the register message may comprise at least one of an IP address, a MAC address, an authentication type and a supported service of the new server. When receiving the register message, in step S720, the client computer 210 determines whether to add the new server. If it is decided to add the new server to the network by the client computer 210, the authentication information corresponding to the new server is also added (step S730). In this embodiment, if a server is presented for the first time, the authentication information corresponding thereto is inputted and stored in the client computer 210. If the server is searched again, the authentication information will be automatically obtained.

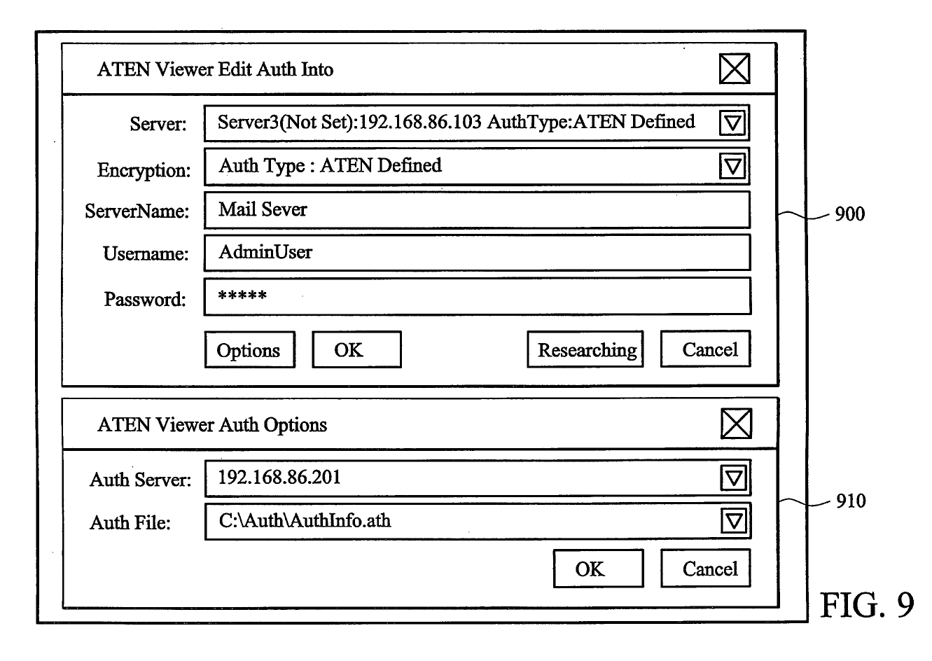

FIG. 9 is a diagram illustrating an exemplary display 900 for generating and editing authentication information of a new server according to the invention. As shown in FIG. 9, the user may automatically obtain the server information and encryption type from the register message, and manually input or edit the information such as input server name, user name and password used by the new server, so that the authentication information can be retrieved and used to log into the new server later. The authentication information may be stored in a database or file of the client computer 210 as default. The authentication information may also be stored in a specific file of a specific server serving as an authentication server, as shown in display 910 of FIG. 9. In this case, the client computer 210 may obtain authentication information corresponding to the selected server from the authentication server.

After the authentication information corresponding to the new server has been added, the new server is added and displayed in the selection list (step S740). Therefore, allowing a user in the client computer 210 to select and control the new server from the selection list.

In some embodiments, each user may have an authority or a group setting for identifying its personality. In this case, the selection list may be generated based on the authority or the group setting of the user. In other words, the selection list presented may be different from one user to another, providing more security and priority access.

In some embodiments, the purposed method may also be applied in controlling more than one server. For example, the client computer 210 may switch the control between Server1 and Server2 as shown in FIG. 4. A user may press a specific function key or a specific button to perform the server switching operation. If the server switching operation has been activated, a switch menu will be displayed instructing the user the manner in which the user is to switch the control between the servers.

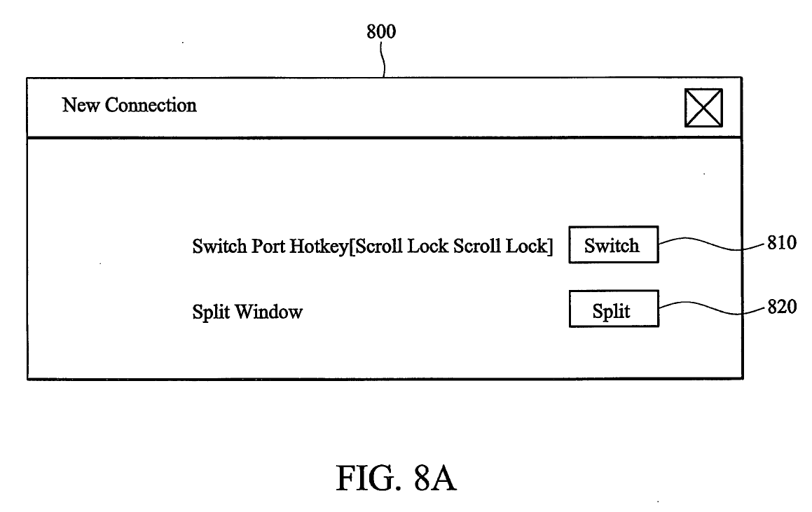

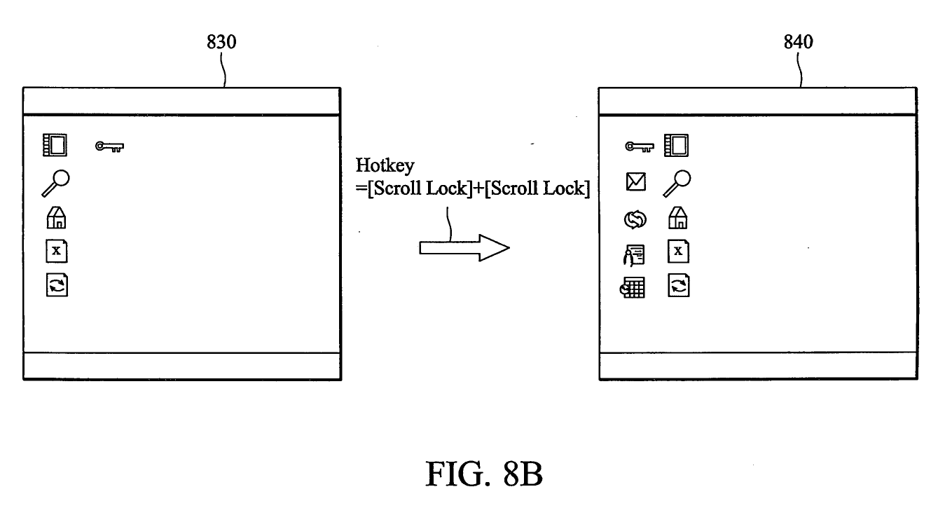

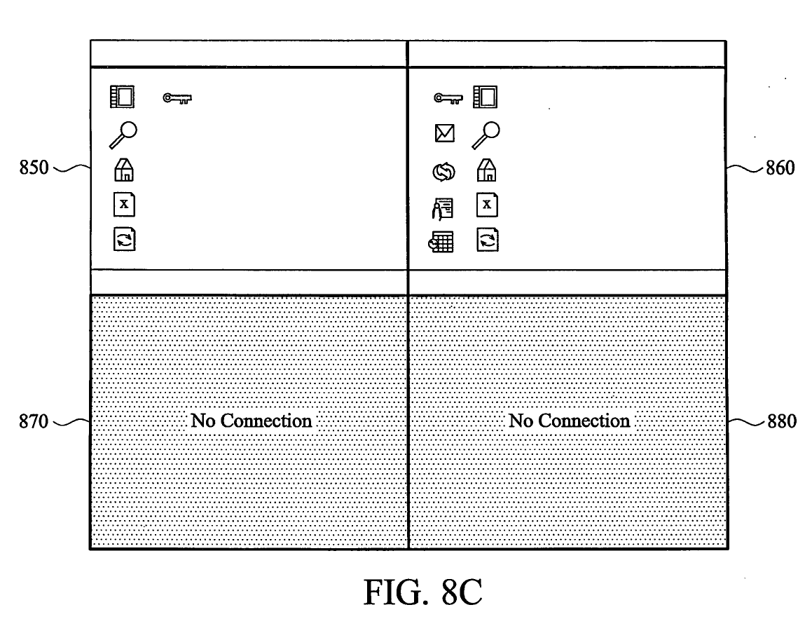

FIG. 8A is a diagram illustrating an exemplary switch menu 800 according to the invention. As shown in FIG. 8A, two switching method options are provided: “switch” (i.e. switch by hotkey) 810 or “split” (i.e. switch by split window) 820. The hotkey may comprise a combination of keys, such as a combination of the [Scroll Lock] key plus [Scroll Lock] key or the [Scroll Lock] key plus a number key from keyboard or buttons combination from mouse, in which each number indicates a specific server which is available to be switched to. If option “switch” is selected, all of the selected servers are switched by pressing the predefined hotkey and only one of the selected servers are displayed and monitored as shown in FIG. 8B. If option “split” is selected, a group of the selected servers are displayed and monitored at the same time as shown in FIG. 8C.

After the switching option has been selected, the user may select another server within the selection list. The authentication information according to the selected another server is then automatically retrieved and loaded to log into the another selected server. Thus, the user may switch from the selected server to the another selected server to control the another selected server in the client computer 210 by the selected switching option.

FIG. 8B is a diagram illustrating an exemplary display for switching servers by the hotkey according to the invention. Referred together with FIGS. 4 and 8B, in this embodiment, it is assumed that the hotkey is defined as a combination of [Scroll Lock] key plus [Scroll Lock] key, Server1 and Server2 are successfully logged into, and the controlled server is Server1. If the hotkey is pressed, the control is switched from Server1 to Server2 and the displayed monitor or desktop is changed from that of Server1 830 to that of server2 840, accordingly. If the hotkey is pressed again, the control is switched back to Server1 and the displayed monitor or desktop is changed back to that of server1 830.

FIG. 8C is a diagram illustrating an exemplary display for switching servers by the split window according to the invention. It is assumed that both Server1 and Server2 are successfully logged into and the split window is capable of displaying four desktop information corresponds to the servers. As shown, information of the Server1 850 and the Server2 860 are displayed in adjacent split frame windows together in the client computer, while information of split frame windows 870 and 880 are shaded as only two servers are monitored by the client computer. As shown, Server1 and Server2 can be simultaneously monitored and controlled in the split window format.

Moreover, the storage device 216 of the client computer 210 may be utilized by the at least one server when the at least one server is connected to the client computer 210. Therefore, the storage device 216 can be utilized as a virtual storage device even if there is no storage device in the connected server.

In summary, with the systems and methods for a client computer to manage a plurality of servers via a network by the invention, all of the servers supporting the iKVM function can be automatically discovered and logged into by a simple selection method without the user being required to memorize or repeatedly input information. As a result, remote control of the plurality of servers is made more simplified and convenient.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A method for a client computer managing a plurality of servers via a network, comprising:
displaying a selection list of the servers supporting a keyboard-video-mouse (KVM) over IP (iKVM) function in the client computer, wherein the selection list provides information corresponding to each server;
selecting at least one server from the selection list in the client computer; and
logging into the selected server to connect the client computer to the selected server such that the client computer is capable of controlling the selected server.

2. The method of claim 1, wherein the selection list further provides information indicating whether each server within the selection list comprises an IPMI module.

3. The method of claim 2, further comprising:
controlling the server through the IPMI module by the client computer.

4. The method of claim 1, wherein the displaying step further comprises:
searching in a predetermined network area for the servers supporting the iKVM function;
generating a search result; and
displaying the selection list corresponding to the generated search result.

5. The method of claim 4, wherein the searching step further comprises:
broadcasting at least one message to the servers within the predetermined network area; and
receiving at least one response message from each server supporting the iKVM function.

6. The method of claim 5, wherein the response message further provides information indicating at least one of an IP address, a MAC address, an authentication type and a supported service of each server.

7. The method of claim 6, wherein the authentication type is an advanced encryption standard (AES) or a user-defined standard type.

8. The method of claim 1, further comprising:
selecting another server from the selection list in the client computer;
logging into the another selected server; and
switching from the selected server to the another selected server to control the another selected server in the client computer.

9. The method of claim 8, further comprising:
switching from the selected server to the another selected server by a hotkey or a split window in the client computer.

10. The method of claim 9, wherein the hotkey comprises a combination of keys.

11. The method of claim 1, further comprising:
sending a request to the client computer when a new server is added to the predetermined network area; and
determining whether to add the new server to the selection list by the client computer.

12. The method of claim 1, wherein the logging step further comprises:
retrieving authentication information corresponding to the selected server from a predefined database in the client computer; and
logging into the selected server by using the retrieved authentication information.

13. The method of claim 1, further comprising providing a viewer application that provides a user interface for displaying the selection list and controlling the selected server.

14. The method of claim 1, wherein the displaying step further comprises determining the selection list according to an authority or a group setting.

15. A remote control system, comprising:
at least one server having an iKVM module for supporting KVM over IP functions; and
a client computer coupled to the server via a network, wherein the client computer displays a selection list for providing information corresponding to the server;
wherein the client computer selects the at least one server from a selection list, such that the client computer logs into the selected server, connects to the selected server, and controls the selected server.

16. The remote control system of claim 15, wherein the at least one server further comprises an IPMI module supporting IPMI standard, and the client computer is capable of controlling the at least one server by the IPMI module.

17. The remote control system of claim 15, wherein the client computer further comprises a storage device, wherein the storage device is utilized by the at least one server when the at least one server is connected to the client computer.

18. A method for a client computer managing a plurality of servers via a network, comprising:
providing a viewer application in the client computer;
searching for servers supporting a KVM over IP (iKVM) function from the plurality of servers by the viewer application;
listing the supported servers and information corresponding thereto, wherein the listed information of each supported server provides information indicating whether each support server comprises an IPMI module;
selecting from the listed servers at least one server by the client computer; and
loading authentication information corresponding to the selected server by the viewer application to connect the client computer to the selected server such that the client computer is capable of controlling the selected server.

19. The method of claim 18, wherein the loading authentication information step further comprises:
retrieving authentication information corresponding to the selected server from a file in the client computer or from a predetermined server.

20. The method of claim 18, further comprising:
selecting a first server from the listed servers;
automatically loading authentication information corresponding to the selected first server to connect the client computer to the selected first server;
selecting a second server from the listed servers;
automatically loading authentication information corresponding to the second server to connect the client computer to the selected second server; and
switching between the first and second servers by a hotkey or a split window in the client computer.
